(19) United States
(12) Patent Application Publication
(10) Pub. No.: US 2026/0186912 A1
(43) Pub. Date: Jul. 2, 2026

(54) DUAL SCANNING OF VOLUME FOR EFFICIENT RESTORE OF SINGLE FILES IN A DEDUPLICATED ENVIRONMENT

(71) Applicant: Eon IO, Ltd., Tel Aviv (IL)

(72) Inventors: Dmitry KUZNETSOV, Tel Aviv Yafo (IL); Assaf NATANZON, Tel Aviv (IL); Sigal WEINER, Holon (IL); Haim BEN-SHIMOL, Kfar Saba (IL); Ron KIMCHI, Tel Aviv (IL); Ofir EHRLICH, Tel Aviv (IL)

(73) Assignee: Eon IO, Ltd., Tel Aviv (IL)

(21) Appl. No.: 19/002,274

(22) Filed: Dec. 26, 2024

(51) Int. Cl. G06F 11/14

(52) U.S. Cl. CPC G06F 11/1466; G06F 11/1453; G06F 11/1464; G06F 11/1469

(57) ABSTRACT

A method and system for restoring a single file from a backup of a block device storage in a cloud computing environment. The method includes reading a filesystem of a virtualization deployed in the cloud computing environment to detect a plurality of files stored on a block device storage; generating in the cloud computing environment a file-level backup including a plurality of backup objects, each backup object generated to minimize file fragmentation; and generating in the cloud computing environment a block-level backup of the block device storage, wherein the block-level backup is deduplicated based on the file-level backup.

### TECHNICAL FIELD

The present disclosure relates generally to the restoration of single files utilizing block-level and file-level backups.

### BACKGROUND

File-level and block-level backups are two common approaches to safeguarding data, each with distinct strengths and weaknesses. File-level backups focus on copying individual files and their metadata. One of their primary advantages is simplicity. They are easy to implement and manage, making them ideal for backing up specific files or folders without capturing unnecessary data. Additionally, they provide clear visibility into the backed-up contents, allowing users to restore specific files quickly. This granularity can save time and storage space when only partial recovery is needed.

However, file-level backups can be slower for large datasets, as they involve scanning and copying each file individually. They are also less efficient for systems with numerous small files, as the overhead for managing metadata can become significant. Furthermore, file-level backups often do not capture open files or system states effectively, limiting their usefulness for complete system restoration.

Block-level backups, on the other hand, operate at a lower level, capturing data in fixed-sized or variable-sized blocks directly from the storage medium. This approach is highly efficient, especially for large datasets or systems with minimal changes, as it only backs up modified blocks. It is faster and more storage-efficient compared to file-level backups. Additionally, block-level backups can capture the entire system state, making them ideal for full-system restoration or disaster recovery scenarios. However, this method has drawbacks. It lacks the granular visibility of file-level backups, making it harder to identify specific files for restoration. Block-level backups can also be complex to configure and require advanced tools to interpret and restore data. They are less effective for backing up individual files, as the block-level approach does not inherently distinguish file boundaries.

It would, therefore, be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments, nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

In one general aspect, the method may include reading a filesystem of a virtualization deployed in the cloud computing environment to detect a plurality of files stored on a block device storage. The method may also include generating in the cloud computing environment a file-level backup including a plurality of backup objects, each backup object generated to minimize file fragmentation. The method may furthermore include generating in the cloud computing environment a block-level backup of the block device storage, where the block-level backup is deduplicated based on the file-level backup. Other embodiments of this aspect include corresponding computer systems, apparatus, and computer programs recorded on one or more computer storage devices, each configured to perform the actions of the methods.

In one general aspect, the non-transitory computer-readable medium may include one or more instructions that, when executed by one or more processors of a device, cause the device to: read a filesystem of a virtualization deployed in the cloud computing environment to detect a plurality of files stored on a block device storage; generate in the cloud computing environment a file-level backup including a plurality of backup objects, each backup object generated to minimize file fragmentation; and generate in the cloud computing environment a block-level backup of the block device storage, where the block-level backup is deduplicated based on the file-level backup. Other embodiments of this aspect include corresponding computer systems, apparatus, and computer programs recorded on one or more computer storage devices, each configured to perform the actions of the methods.

In one general aspect, the system may include one or more processors configured to: System may also include reading a filesystem of a virtualization deployed in the cloud computing environment to detect a plurality of files stored on a block device storage. The system may furthermore include generating in the cloud computing environment, a file-level backup including a plurality of backup objects, each backup object generated to minimize file fragmentation. System may in addition include generating in the cloud computing environment a block-level backup of the block device storage, where the block-level backup is deduplicated based on the file-level backup. Other embodiments of this aspect include corresponding computer systems, apparatus, and computer programs recorded on one or more computer storage devices, each configured to perform the actions of the methods.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example schematic diagram of a virtualization including a block-level storage for backup generation, implemented in accordance with an embodiment.

FIG. 2 is an example schematic illustration of a file-level backup utilizing block-level deduplication, implemented in accordance with an embodiment.

FIG. 3 is a flowchart of a method for performing file-level backup utilizing block-level deduplication, implemented according to an embodiment.

FIG. 4 is an example schematic diagram of a backup generator according to an embodiment.

### DETAILED DESCRIPTION

It is important to note that the embodiments disclosed herein are only some examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

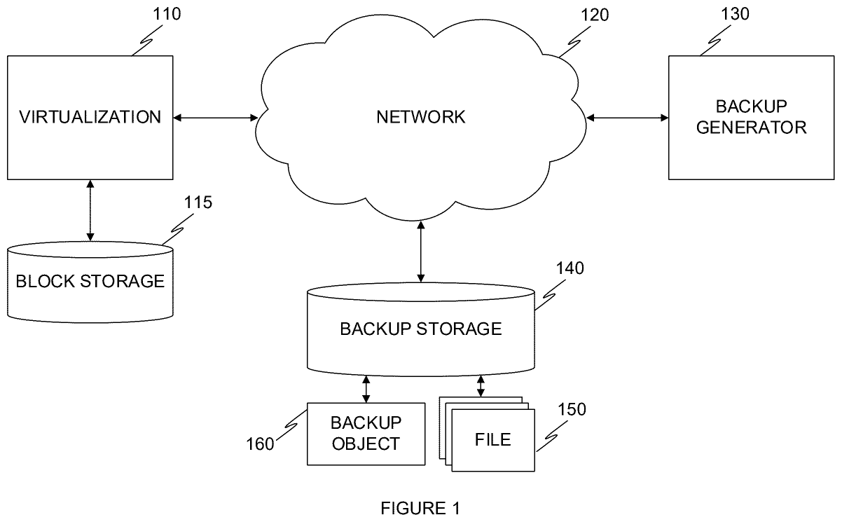

FIG. 1 is an example schematic diagram of a virtualization including a block-level storage for backup generation, implemented in accordance with an embodiment. In an embodiment, a virtualization 110 is a virtual machine, software container, and the like. In some embodiments, the virtualization 110 is associated with a block storage device 115. The backup is of the block storage device 115.

According to an embodiment, the block storage device 115 is configured to store data in fixed-sized blocks, each with a unique address, allowing efficient access and management. Unlike file storage, block storage doesn't organize data hierarchically, instead leaving structure handling to the operating system, applications, and the like. It is ideal for databases, virtual machines, and high-performance applications. An example is an Amazon® Elastic Block Store (EBS) volume, which provides scalable, block-level storage for use with Amazon Elastic Container Cluster (EC2) instances.

In an embodiment, the virtualization 110 is deployed in a computing environment that includes a network 120. In some embodiments, the network 120 provides connectivity for the computing environment, utilizing various network interfaces, network protocols, etc.

In some embodiments, the computing environment is an on-prem environment, a hybrid environment, a cloud computing environment, a combination thereof, and the like. A computing environment includes, for example, a virtual private cloud, a virtual network, a virtual private network, a combination thereof, and the like.

According to an embodiment, the cloud computing environment is deployed on a cloud computing infrastructure, such as Amazon® Web Service (AWS), Google® Cloud Platform (GCP), Microsoft® Azure, and the like. In an embodiment, the network further provides connectivity to a backup storage 140 and a backup generator 130. In an embodiment, the backup generator 130 is a computer server implemented, for example, as a virtual machine, a software container, a serverless function, a combination thereof, and the like.

In an embodiment, the backup generator 130 is configured to access the block storage 115 of the virtualization 110, and generate a backup therefrom. In some embodiments, a backup is generated periodically. In certain embodiments, a plurality of periodic backups are generated, each corresponding to a restoration point.

In some embodiments, the backup generator 130 is configured to access a filesystem of the block storage 115. According to an embodiment, a filesystem is a system used by an operating system to organize, store, and retrieve data on storage devices. It manages data as files and directories, keeping track of their locations, sizes, and metadata. Filesystems ensure efficient storage allocation, provide access permissions, and maintain data integrity. Examples include NTFS, ext4, and APFS.

According to certain embodiments, the backup generator 130 is configured to read files from the block storage 115 and generate a plurality of files 150 as a backup in a backup storage 140. In some embodiments, the plurality of files is stored as objects in the backup storage 140, such as backup object 160.

For example, a backup storage 140 is implemented, in an embodiment, as Amazon® Simple Storage Service (S3). In an embodiment, the backup generator 130 is configured to generate a manifest for each file to indicate where data blocks of the file are stored (e.g., what backup objects is a particular file stored in). According to an embodiment, the virtualization 110, the backup generator 130, the backup storage 140, a combination thereof, and the like, are deployed in a cloud computing environment.

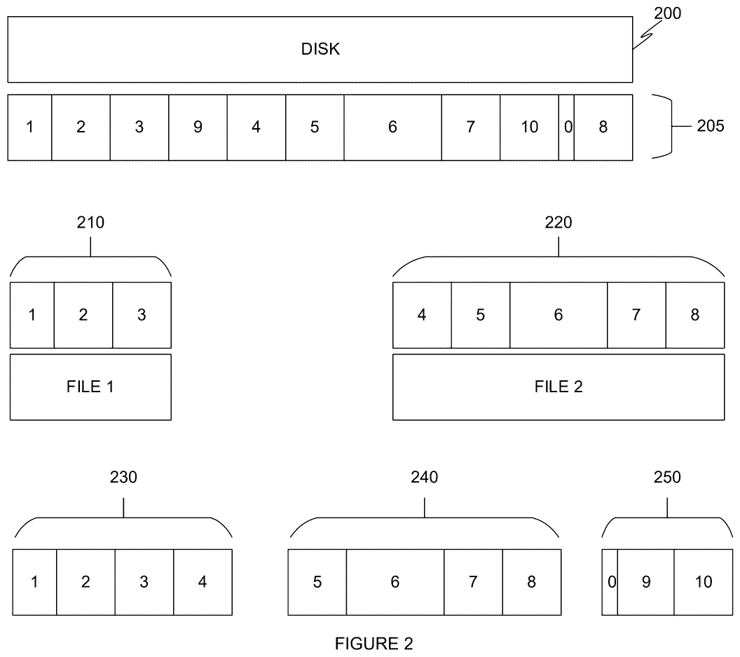

In an embodiment, data blocks of the same file are stored in proximity to each other (e.g., in the same backup object, in backup objects that have proximate addresses, etc.) to minimize the number of objects a file is stored on, which in turn allows for restoration of single files utilizing a minimal amount of compute resources and minimize the access to different objects. This is explained in more detail with respect to FIG. 2 below.

In some embodiments, a backup (e.g., restoration point) includes a file-level backup and a block-level backup. In certain embodiments, a file-level backup is initiated first, and once complete, a block-level backup is generated, which is deduplicated based on the file-level backup. This benefits from the advantages of both the file-level backup scheme and the block-level backup scheme.

FIG. 2 is an example schematic illustration of a file-level backup utilizing block-level deduplication, implemented in accordance with an embodiment. In an embodiment, a disk 200 includes a plurality of files. The disk 200 is a block-level storage device and includes a plurality of data blocks 205. In this example, the data blocks are variable-sized and numbered 0 through 10, though in a fragmented order.

In an embodiment, the disk 200 includes a first file 210, which is stored on blocks 1 through 3, and a second file 220 is stored on blocks 4 through 8. By configuring a backup generator to read the filesystem and detect the files, the backup objects 230 through 250 are generated such that they correspond to the file structure.

For example, a first backup object 230 includes blocks 1 through 4, a second backup object 240 includes blocks 5 through 8 and a third backup object includes blocks 0, 9, and 10. In order to restore the first file 230, a manifest associated with the first file is read, and this allows determining that the first backup object 230 is required for restoring the first file 230. It should be noted that several files can be backed up to the same object, and the manifest will point to different locations within the object. Further, a large file may span multiple objects in the backup.

In order to restore the second file 220, it is enough to read the first data object 230 and the second data object 240, and there is no need to read the third data object 250, unless a full system restore is required. It should be noted that a full system restore is required case the data is readily available. Thus, the benefit of both file-level backup and block-level backup is realized when restoring single files or restoring the entire system to an earlier state.

In one embodiment, a snapshot of the virtualization is taken before backing it up. The disks attached to a backup generator are then used to store the backup.

It is important to note that the file system may occupy part of a volume (i.e., a partitioned volume) or span multiple volumes (using a volume manager). In the disclosed embodiments, regardless of the configuration, the file systems on the volume are backed up, and then the entire volume or volumes are backed up. Typically, backup systems create a backup of both the device and the block device. Afterward, these systems generate a list of the files backed up from the block device. During the restoration process, the block device is mounted, and the files are then extracted.

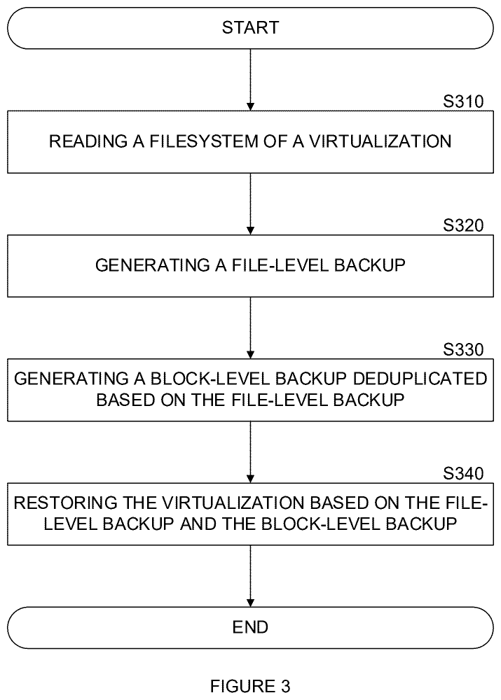

FIG. 3 is a flowchart of a method for performing file-level backup utilizing block-level deduplication, implemented according to an embodiment. In an embodiment, performing file-level backup utilizing block-level deduplication allows for benefit from the ability to restore single files in an efficient and computationally cheap manner, while also providing the speed and accuracy of block-level restoration.

At S310, a filesystem is read. In an embodiment, the filesystem is a block-level storage device of a virtualization deployed in a cloud computing environment. A filesystem is a system that organizes, stores, and manages data on storage devices like hard drives or SSDs. It defines how files are named, stored, retrieved, and accessed, using structures like directories, files, and metadata. Filesystems also handle file permissions, security, and data integrity. Examples include NTFS, ext4, and APFS.

In an embodiment, the filesystem is read to detect a plurality of files and their locations (i.e., block addresses) in a block-level storage device. In some embodiments, a backup generator is provided with credentials to access a block-level storage device in a cloud computing environment.

At S320, a file-level backup is generated. In an embodiment, the file-level backup is generated for a first time. In some embodiments, the file-level backup includes generating a plurality of backup objects, such as storage blobs. In some embodiments, the backup objects are stored in a cloud storage, such as AWS S3.

In an embodiment, the file-level backup includes generating a backup object which includes therein a plurality of data blocks, at least a portion of which are associated with a first file.

In some embodiments, the file-level backup includes a manifest that is generated for each file for a plurality of files, etc. It should be noted that the manifests are stored in objects, for example, in S3. Each such object contains the manifests of multiple files (not an object per file. In some embodiments, the manifest includes a location, a pointer, an address, a mapping, and the like, for locating a data block associated with a file. According to an embodiment, each data block which is associated with a file of the filesystem is stored in a backup object of a plurality of backup objects.

At S330, a block-level backup is generated. In an embodiment, the block-level backup is generated utilizing deduplication which is based on the file-level backup. For example, according to an embodiment, a data block which is stored in a backup object when generating the file-level backup, is not stored in the block-level backup.

In certain embodiments, the block-level backup allows restoring a system including each and every data block, while storing certain data blocks in locations that utilize file-level backup efficiency when restoring single files.

In an embodiment, the block-level backup includes fixed-size blocks, variable-size blocks, etc. In some embodiments, for example, where a fixed-size block is selected, the block size is selected to be a divisor of a block size of the file system. For example, where the block size of the filesystem is 8 kb, a block size of the block-level backup is 8 kb, 4 kb, etc.

At S340, restoration is initiated. In an embodiment, a restoration request includes a restoration of the entire system (i.e., block-level restoration), single file restoration, a combination thereof, and the like.

In some embodiments, where a single file is selected for restoration, multiple single files are selected for restoration, etc., a manifest of the file is accessed to determine which backup objects should be read.

In an embodiment, in a file-level restoration, the backup objects are read, and the relevant data blocks are extracted from the backup object, allowing the file to be restored from the relevant data blocks. In some embodiments, a restoration request includes a full system restoration, which includes restoring a block device. In an embodiment, this includes reading backup objects of the block-level backup and backup objects of file-level backup objects to extract from each data block, and initiating a full block device restoration from all the extracted data blocks.

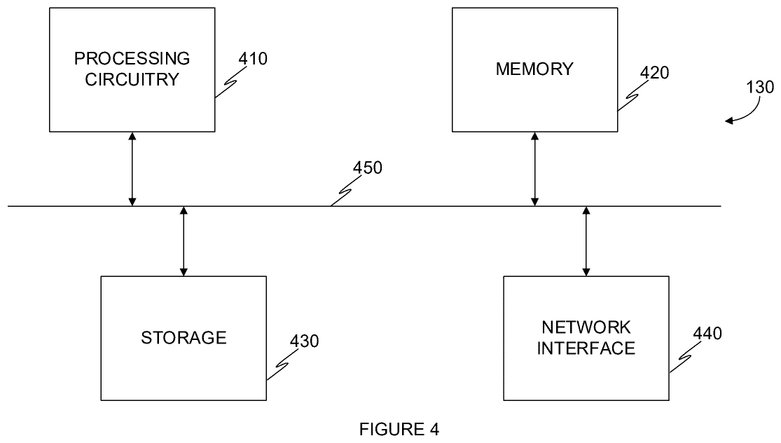

FIG. 4 is an example schematic diagram of a backup generator 130 according to an embodiment. The backup generator 130 includes, according to an embodiment, a processing circuitry 410 coupled to a memory 420, a storage 430, and a network interface 440. In an embodiment, the components of the backup generator 130 are communicatively connected via a bus 450.

In certain embodiments, the processing circuitry 410 is realized as one or more hardware logic components and circuits. For example, according to an embodiment, illustrative types of hardware logic components include field programmable gate arrays (FPGAs), application-specific integrated circuits (ASICs), Application-specific standard products (ASSPs), system-on-a-chip systems (SOCs), graphics processing units (GPUs), tensor processing units (TPUs), Artificial Intelligence (AI) accelerators, general-purpose microprocessors, microcontrollers, digital signal processors (DSPs), and the like, or any other hardware logic components that are configured to perform calculations or other manipulations of information.

In an embodiment, the memory 420 is a volatile memory (e.g., random access memory, etc.), a non-volatile memory (e.g., read-only memory, flash memory, etc.), a combination thereof, and the like. In some embodiments, the memory 420 is an on-chip memory, an off-chip memory, a combination thereof, and the like. In certain embodiments, the memory 420 is a scratch-pad memory for the processing circuitry 410.

In one configuration, software for implementing one or more embodiments disclosed herein is stored in the storage 430, in the memory 420, in a combination thereof, and the like. Software shall be construed broadly to mean any type of instructions, whether referred to as software, firmware, middleware, microcode, hardware description language, or otherwise. Instructions include, according to an embodiment, code (e.g., in source code format, binary code format, executable code format, or any other suitable format of code). The instructions, when executed by the processing circuitry 410, cause the processing circuitry 410 to perform the various processes described herein, in accordance with an embodiment.

In some embodiments, the storage 430 is a magnetic storage, an optical storage, a solid-state storage, a combination thereof, and the like, and is realized, according to an embodiment, as a flash memory, as a hard-disk drive, another memory technology, various combinations thereof, or any other medium which can be used to store the desired information.

The network interface 440 is configured to provide the backup generator 130 with communication with, for example, the network 120, the virtualization 110, the backup storage 140, and the like, according to an embodiment.

It should be understood that the embodiments described herein are not limited to the specific architecture illustrated in FIG. 4, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more processing units (“PUs”), a memory, and input/output interfaces. The computer platform may also include an operating system and microinstruction code. The various processes and functions described herein may be either part of the microinstruction code or part of the application program, or any combination thereof, which may be executed by a PU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to the first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for restoring a single file from a backup of a block device storage in a cloud computing environment, comprising:
reading a filesystem of a virtualization deployed in the cloud computing environment to detect a plurality of files stored on a block device storage;
generating in the cloud computing environment a file-level backup including a plurality of backup objects, each backup object generated to minimize file fragmentation; and
generating in the cloud computing environment a block-level backup of the block device storage, wherein the block-level backup is deduplicated based on the file-level backup.

2. The method of claim 1, further comprising:
receiving a request to restore a file of the plurality of files;
reading at least a backup object of the plurality of backup objects, wherein the backup object includes at least a portion of the file; and
restoring the file based on the at least a backup object.

3. The method of claim 1, further comprising:
generating a first backup object including a first plurality of chunks corresponding to a first file.

4. The method of claim 3, further comprising:
generating a second backup object including a second plurality of chunks corresponding to the first file, and a third plurality of chunks corresponding to a second file.

5. The method of claim 4, further comprising:
receiving a request to restore the first file; and
restoring the first file based on the first backup object and the second backup object, wherein the first backup object and the second backup object are stored sequentially.

6. The method of claim 5, wherein the first backup object and the second backup object are stored in an object storage of the cloud computing environment.

7. The method of claim 1, further comprising:
restoring the virtualization based on the file-level backup and the block-level backup.

8. The method of claim 1, further comprising:
deduplicating the block-level backup utilizing a variable-size block.

9. The method of claim 1, further comprising:
deduplicating the block-level backup utilizing a fixed-size block.

10. The method of claim 9, wherein the fixed size block is a divisor of a block size of the filesystem.

11. The method of claim 1, further comprising:
generating for each file of the plurality of files a manifest record, wherein the manifest points to a storage address of a backup object where at least a portion of a file is stored.

12. A non-transitory computer-readable medium storing a set of instructions for restoring a single file from a backup of a block device storage in a cloud computing environment, the set of instructions comprising:
one or more instructions that, when executed by one or more processors of a device, cause the device to:
read a filesystem of a virtualization deployed in the cloud computing environment to detect a plurality of files stored on a block device storage;
generate in the cloud computing environment a file-level backup including a plurality of backup objects, each backup object generated to minimize file fragmentation; and
generate in the cloud computing environment a block-level backup of the block device storage, wherein the block-level backup is deduplicated based on the file-level backup.

13. A system for restoring a single file from a backup of a block device storage in a cloud computing environment comprising:
one or more processors configured to:
read a filesystem of a virtualization deployed in the cloud computing environment to detect a plurality of files stored on a block device storage;
generate in the cloud computing environment a file-level backup including a plurality of backup objects, each backup object generated to minimize file fragmentation; and
generate in the cloud computing environment a block-level backup of the block device storage, wherein the block-level backup is deduplicated based on the file-level backup.

14. The system of claim 13, wherein the one or more processors are further configured to:
receive a request to restore a file of the plurality of files;
read at least a backup object of the plurality of backup objects, wherein the backup object includes at least a portion of the file; and
restore the file based on the at least a backup object.

15. The system of claim 13, wherein the one or more processors are further configured to:
generate a first backup object including a first plurality of chunks corresponding to a first file.

16. The system of claim 15, wherein the one or more processors are further configured to:
generate a second backup object including a second plurality of chunks corresponding to the first file and a third plurality of chunks corresponding to a second file.

17. The system of claim 16, wherein the one or more processors are further configured to:
receive a request to restore the first file; and
restore the first file based on the first backup object and the second backup object, wherein the first backup object and the second backup object are stored sequentially.

18. The system of claim 17, wherein the first backup object and the second backup object are stored in an object storage of the cloud computing environment.

19. The system of claim 13, wherein the one or more processors are further configured to:
restore the virtualization based on the file-level backup and the block-level backup.

20. The system of claim 13, wherein the one or more processors are further configured to:
deduplicate the block-level backup utilizing a variable-size block.

21. The system of claim 13, wherein the one or more processors are further configured to:
deduplicate the block-level backup utilizing a fixed-size block.

22. The system of claim 21, wherein the fixed size block is a divisor of a block size of the filesystem.

23. The system of claim 13, wherein the one or more processors are further configured to:
generate for each file of the plurality of files a manifest record, wherein the manifest points to a storage address of a backup object where at least a portion of a file is stored.
